(19) United States
(12) Patent Application Publication
(10) Pub. No.: US 2026/0212408 A1
(43) Pub. Date: Jul. 23, 2026

(54) COLLABORATIVE ARTIFACT PROCESSING PLATFORM

(71) Applicant: Citibank, N.A., New York, NY (US)

(72) Inventors: Camille Garcia, Miami Beach, FL (US); John J. Selvin, Dublin (IE)

(21) Appl. No.: 19/031,330

(22) Filed: Jan. 17, 2025

(51) Int. Cl. G06Q 40/02

(52) U.S. Cl. CPC G06Q 40/02

(57) ABSTRACT

Described herein are systems and methods for generating, vetting, and/or revising artifacts. In some implementations, the systems and methods herein utilize artificial intelligence models to analyze and artifact to identify the contents of the artifact and/or to identify alternative signals that can be utilized in the artifact.

### BACKGROUND

Digital artifacts can include a number of signals. Digital artifacts are often similar to other digital artifacts used for similarly purposes, but digital artifacts may be customized to particular applications. For example, a digital artifact can be a standby letter of credit, bank guarantee, etc. Such digital artifacts are commonly used in commercial transactions. However, current approaches to creating digital artifacts have several drawbacks. Accordingly, there is a need for improved approaches to creating such artifacts.

### BRIEF DESCRIPTION OF THE DRAWINGS

FIG. 1 is a flowchart that illustrates an example process for generating an artifact according to some implementations.

FIG. 2 is a flowchart that illustrates an example process for determining and applying artifact constraints according to some implementations.

FIG. 3A is a drawing that illustrates an example user interface according to some implementations.

FIG. 3B is a drawing that illustrates another view of the user interface according to some implementations.

FIG. 4 is a flowchart that illustrates an example process for determining a fallback signal and updating an artifact according to some implementations.

FIG. 5 is a flowchart that illustrates an example process for updating an artifact with a fallback signal according to some implementations.

FIG. 6 is a flowchart that illustrates an example process for identifying missing signals and inserting signals into an artifact according to some implementations.

FIG. 7 is a flowchart that illustrates an example cascaded analysis according to some implementations.

FIG. 8 is a block diagram showing some of the components typically incorporated in at least some of the computer systems and other devices on which the disclosed platform operates.

FIG. 9 is a system diagram illustrating an example of a computing environment in which the disclosed platform operates in some implementations.

FIG. 10 is an illustrative diagram showing a machine learning model, in accordance with some implementations of the present technology.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the specific implementations described. On the contrary, the technology is intended to cover all modifications, equivalents, and alternatives falling within the scope of the technology as defined by the appended claims.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Digital artifacts are often made up of many signals that define specific conditions, quantities, values, restrictions, rules, and so forth for carrying out a transaction. Such transactions can be digital transactions, physical transactions, or both. Often, a single entity will utilize many different digital artifacts (also referred to herein simply as “artifacts”). The entity may want such artifacts to be generally consistent with one another while being tailored for particular uses. Digital artifacts are often inconsistent with one another, leading to uncertainty or confusion as well as a general lack of quality. Described herein are approaches that can be used to automatically vet digital artifacts and the signals therein. In some implementations, the approaches herein automatically recommend signals for use in artifacts. In some implementations, the approaches herein automatically complete tokenized signals based on supplied or extracted metadata, as described in more detail herein.

As an example, standby letters of credit (SBLCs) and guarantees are commonly issued by financial institutions to facilitate commercial transactions. However, as described herein, there are many complications and difficulties associated with these and other financial documents, contracts, and so forth (generally referred to herein as artifacts). Described herein are techniques that can improve the speed, consistency, and/or quality of artifacts. For simplicity and ease of understanding, the following discussion is provided largely in the context of SBLCs, but it will be appreciated that the approaches described herein can be applied to guarantees, other types of letters of credit, and so forth. Moreover, the approaches described herein can be applied to certain contracts or more generally to any artifact including, for example, smart contracts or contracts that automatically or self-execute. The approaches described herein can be especially advantageous in cases where artifacts contain signals (e.g., clauses) that are the same or similar to signals in other artifacts, such as service agreements, sales contracts, and so forth that often reuse signals, such as payment terms, warranty disclaimers, choice of law provisions, and so forth.

An SBLC is a financial instrument issued by a guarantor (e.g., a bank) on behalf of an applicant (also referred to herein as a client) for the benefit of a beneficiary. The SBLC serves as a guarantee to the beneficiary that the guarantor will fulfill the applicant's obligations or otherwise compensate the beneficiary if the applicant fails to satisfy their obligations, such as making payments on time or meeting certain project milestones. SBLCs are commonly used in a wide variety of transactions, ranging from routine trade to complex projects and business relationships. For example, SBLCs are commonly used in international trade where a merchant in the United States imports goods from a manufacturer outside the United States. SBLCs are also commonly used for large construction projects to provide protection in cases where a contractor fails to perform on time or otherwise to meet their obligations. Guarantees can serve a similar purpose while the manner of operation can differ.

SBLCs and other artifacts (e.g., guarantees) play an important role in risk mitigation, credit enhancement, and so forth. For example, the beneficiary of an SBLC can mitigate their risk because they can go to the guarantor (typically a bank) for payment if the applicant fails to meet their obligations. Applicants can, in effect, use the guarantor's creditworthiness as a substitute for their own, which can enable them to enter into contracts (e.g., for goods or services) that would otherwise be viewed as overly risky.

As described above, SBLCs and other artifacts play an important role in a variety of commercial interactions. however, the current processes for preparing SBLCs, guarantees, and other artifacts are cumbersome, inefficient, and prone to errors and inconsistencies. For example, preparing an SBLC can involve extensive communication between the applicant and the guarantor, often over email or phone, leading to numerous iterations and significant idle time between exchanges. This back-and-forth communication not only delays the preparation process, but also increases the likelihood of inconsistencies and errors. Often, draft SBLC language is provided to the applicant by the beneficiary, which can add another layer and further complicate and delay communications. Additionally, a lack of standardization in language can lead to frustration, confusion, and potentially unexpected or unwanted legal and/or financial risks. For example, an applicant may submit the same or similar signals for multiple SBLCs, and the applicant may receive different suggested changes based on who reviews the signals at the financial institution. Even if the same person reviews multiple artifacts for the same applicant, the person may provide inconsistent feedback.

Inefficiencies can lead to significant delays in the conduct of business transactions. For example, it can take several days, weeks, or longer to reach agreed upon language for an SBLC. There are often high costs associated with issuing SBLCs, as financial institutions need to cover the cost associated with the significant resources invested into preparing and issuing such instruments. Financial institutions often charge fees based on, among other things, the total amount of an SBLC and the total length of time the SBLC is open. Fees can make clients reluctant to use SBLCs as the cost of doing so can be a significant expense to the client's business. Financial institutions may place certain minimums on SBLCs to ensure that the fees are sufficient to cover the cost of preparing and processing an SBLC, which can place SBLCs out of reach of smaller clients or make them less suitable for use in smaller transactions.

Financial and legal artifacts can include a large amount of information. This information can be general information (e.g., information that is not specific to a particular client, transaction, etc., such as a general warranty disclaimer or choice of law provision) or specific information (e.g., information that is related to a specific client, transaction, etc., such as names, addresses, amounts, dates, etc.). For example, an SBLC can include information about the parties (e.g., guarantor, applicant, beneficiary, obligor (if different from applicant), protective issuing bank), commercial information (e.g., commercial contract information, purpose of the guarantee), dates and other references (e.g., guarantee reference number, issuance date, expiry date (e.g., a fixed date, open-ended, evergreen), expiry conditions, cancelation conditions), guarantee amount information (e.g., amount, currency, gross-up clause, payment conditions, partial claim conditions, multiple claim conditions, fee conditions), claim terms (e.g., conditions for claim, form of claim, place of claim, reimbursement period, discrepant claim handling), law and rules information (e.g., governing rule, governing law, place of jurisdiction, arbitration rules), regulatory information (e.g., sanctions clause, GDPR clause, bail in conditions), annex information (e.g., claim template, reduction schedule), definitions (e.g., what is considered a banking holiday), and/or other information (e.g., transfer clause (freely transferable with guarantor consent, freely transferable without guarantor consent, non-transferable), assignment clause (e.g., assignable with guarantor consent, assignable without guarantor consent, non-assignable).

As can be readily appreciated from the preceding discussion, SBLCs and other artifacts, while important for conducting business, can be complex documents with significant legal and financial implications. Current approaches to preparing SBLCs and other artifacts can be slow, expensive, and inconsistent. Accordingly, there is a need for approaches that can streamline the vetting, generation, and processing of artifacts. In some implementations, the approaches herein can be used to reduce the preparation time for artifacts, improve consistency between artifacts, reduce the costs associated with artifacts, and so forth.

An SBLC transaction typically begins with a text vetting process in which the signals within an artifact are reviewed by the obligor. An entity (e.g., a client, applicant, beneficiary, or other interested party) can submit proposed text for the SBLC that includes specific terms of the credit, including any required documents or other conditions for making a claim. In some cases, particularly for larger or more complex matters, SBLCs may be complex, negotiated documents. It is important that the guarantor (e.g., the bank) vet the text of the SBLC to understand and limit potential risk to the guarantor, for example by placing limits and/or conditions on payments or making sure that the SBLC does not impose obligations other than financial on the guarantor.

In conventional approaches, the text vetting process often involves lengthy back-and-forth discussion between the client and financial institution, and in many cases, among internal stakeholders within the financial institution. As described herein, there can be significant idle time as different stakeholders provide into the process. Moreover, conventional processes are often memoryless; that is, past transactions, patterns, etc., may not be taken into consideration for future transactions, leading to inconsistencies. Additionally, there typically is little or no audit trail to help understand how text changed during preparation, and even if such information does exist, it may be scattered across multiple emails, word processing documents, and so forth, and thus difficult to determine what happened and how text evolved.

Attempting to create a platform for vetting and processing artifacts in view of the available conventional approaches created significant technological uncertainty. Creating such platform required addressing several unknowns such as how to ensure that a platform can automatically analyze an artifact and determine which parts of the artifact (e.g., which signals) are acceptable, which need further review, and which need revision. Achieving a high degree of accuracy is important as mistakes can lead to greater financial and/or legal risk or may even render an artifact invalid or unenforceable.

Conventional approaches rely on human back and forth and human vetting of artifacts, which results in delays, inconsistencies, errors, and so forth. Conventional human-driven artifact preparation and vetting typically lacks historical context, may not catch errors that present significant risk, and so forth. Conversely, the approaches described herein can automatically vet artifacts based on historical data and can, in some implementations, make suggestions to improve an artifact based on factors such as the risk preferences of a financial institution, the language used in other artifacts, and so forth.

To overcome the technological uncertainties, the inventors systematically evaluated multiple design alternatives. For example, the inventors evaluated different levels of analysis (e.g., entire artifact, page-level, paragraph level, section level, etc.), using different thresholds for determining whether signals are approved, require further review (e.g., manual review), or are rejected, and different approaches for identifying similar historically-used signals, such as whether or not to tokenize signals and if so, how to do so.

The use of conventional techniques has proved to be cumbersome, time-intensive, expensive, and prone to errors, as conventional approaches failed to ensure consistency and offered little or no ability to automatically vet artifacts, leading to delays, errors, decreased utilization of certain artifacts, disrupted business transactions, and so forth. Similarly, building artifacts based only on pre-defined signals did not provide sufficient flexibility, making such an approach unsuitable for artifacts associated with many types of transactions. Further, using artificial intelligence models to generate artifacts has proven unreliable, as such models typically lack contextual and reasoning capabilities to ensure that generated artifacts make sense in the context of a given transaction, comply with applicable laws and regulations, and so forth.

Thus, the inventors experimented with different methods for improving the preparation of artifacts. For example, the inventors experimented with various ways to utilize machine learning/artificial intelligence models to analyze and/or suggest changes to artifacts to identify the most efficient and effective approaches.

Described herein is a platform for vetting artifacts and signals that can be used to improve the speed, accuracy, quality, etc., of artifact preparation. The platform described herein can offer various features, such as a dashboard for managing artifacts, custom text submission, artifact generation (e.g., based on approved text and/or previous transactions), signal identification and/or labeling, metadata and/or placeholder identification and/or labeling, signal approval, fallback signal recommendations, tagging of signals based on usage, signal replacement (e.g., while preserving metadata), signal/artifact amendments within the platform, beneficiary/related party interaction, commenting, signal building, artifact building, etc. In some implementations, the platform described herein includes a signal library that can be maintained by an obligor (e.g., a financial institution). In some implementations, the platform includes signal tagging based on, for example, financial institution, branch, client, governing rule preferences, governing law preferences, beneficiary, etc. In some implementations, the platform includes functionality for determining and applying relevant artifact constraints, such as adding GDPR provisions. In some implementations, the platform includes reporting and/or business insight functionality, such as reporting on the number of artifacts, time to finalize an artifact, aggregate limits, expiry dates, claims or draws against artifacts, and so forth.

In some implementations, a platform takes advantage of specific knowledge and expertise developed over time. This knowledge can be embedded in the technical solution. Over time, practitioners have built a depth of expertise, including in areas such as cross-jurisdictional issues, local market practices, and so forth. Signals can be defined and/or structured based at least in part on this knowledge to enable machine learning techniques to achieve required precision, accuracy, etc., that would be difficult or impossible to achieve using general purpose large language models alone.

While described largely in terms of interactions of an applicant with a platform, it will be appreciated that the platform can also be implemented such that beneficiaries or other interested parties can submit SBLCs or other artifacts and utilize the platform to generate an SBLC or other artifact (e.g., reverse origination). This can be significant as, in many cases, the beneficiary of the artifact is the party that provides the initial draft text for the artifact. Thus, providing this mode of operation may cut down on preparation time as the party who prepared the initial artifact language can review and modify the artifact within the platform directly, rather than going through the applicant to make changes.

In some implementations, an artificial intelligence (Al) model is used to streamline and enhance the process of preparing an artifact such as an SBLC. For example, an Al model such as a large language model (LLM) can break down the text of a proposed artifact into individual signals. Signals can be a single sentence, a single paragraph, etc. In some cases, a signal can span multiple sentences, or a single sentence may contain multiple signals (e.g., a single sentence may mention governing rules, governing law, and governing jurisdiction). In some implementations, an LLM is trained using data comprising signals from SBLCs and/or other artifacts or is a more general purpose LLM used with retrieval augmented generation and/or prompting techniques such as one-shot prompting or few-shot prompting.

In some implementations, identification of pieces of an artifact is performed in one or more stages. For example, in some implementations, a platform uses an Al model (e.g., an LLM) to identify all signals within an artifact. However, other approaches can have certain advantages. Identifying signals in an artifact, identifying similar signals in a signal library, and so forth can be computationally intensive processes. The computational demands can be significant, especially for longer artifacts or for large volumes of artifacts. In many cases, entire sections of artifacts are the same or very similar from artifact to artifact. For example, consider a standby letter of credit. SBLCs often include a paragraph that states that the SBLC is governed by the International Standby Practices published in International Chamber of Commerce Publication No. 590 (1998) and that includes other discussion, such as what happens in the case where the practices are silent. There may be little benefit to breaking down such a paragraph into smaller pieces (e.g., into individual signals) as the entire paragraph is commonly used in many different SBLCs. Thus, in some implementations, a platform may first analyze entire sections, entire paragraphs, etc., of an artifact and can automatically approve entire sections, entire paragraphs, etc., or suggest changes to entire sections, paragraphs, etc., without analyzing the individual signals within the section, paragraphs, etc. For example, the platform can suggest that a governing rule paragraph be replaced with a fallback governing rule paragraph. In addition or alternatively to computational efficiencies that can be gained, such an approach can improve user experiences and consistency of artifacts. For example, rather than a user having to select multiple sentences to construct a paragraph, the user can select an entire paragraph or can even select an entire section rather than selecting individual signals that make up the section. Such techniques can even be extended to entire artifacts. For example, an exporter may provide the same artifact (e.g., SBLC) to all of its customers, with only specific information about the deal (e.g., metadata, as described herein) varying between artifacts.

Proposed text for an artifact typically contains information that is specific to the particular artifact and more general information that is not specific to the artifact and may be reused in multiple artifacts. The specific information is referred to herein as metadata and can include information such as applicant name, guarantor name, beneficiary name, amount, expiry, reference number, address, issuance date, obligor, protective issuing bank, and so forth. In some implementations, a system is configured to identify metadata in proposed signals and to remove the metadata prior to further processing. In some implementations, metadata can be stored for later use, for example as described herein. For example, metadata can be stored as key-value pairs (e.g., in a JSON or YAML file), in a database, etc. In some implementations, metadata can be replaced with tokens. In some implementations, identified metadata is stored for later use, such as substitution into a preapproved signal from a signal library, as described herein. In some implementations, metadata is stored as and/or can be mapped to key-value pairs, in which the key indicates a type of the metadata and the value is or includes the value extracted from received signals or otherwise supplied by a user. As an example, “Beneficiary certifies to Willow Street Bank NA with reference to the Standby Letter of Credit having Reference No. ABC123 dated Jan. 23, 2024, and issued on behalf of Joe's Importing Co. in Exporter Inc's favor that Joe's Importing has failed to make a timely payment” can be tokenized as “Beneficiary certifies to {guarantor} with reference to the Standby Letter of Credit having Reference No. {reference_number} dated {issuance_date} and issued on behalf of {applicant} in {beneficiary}'s favor that {applicant} has failed to make a timely payment.” Such tokenization can be useful when identifying recommended alternative signals (fallback signals), for filling in signals with artifact-specific information (e.g., metadata such as names, dates, amounts), and so forth.

In some implementations, the system is configured to access a signal library to identify identical and/or similar signals (e.g., fallback signals) within the signal library. In some implementations, a signal is selected from the signal library (e.g., by a user or by the system). The signals in the signal library can be tokenized, although this is not necessary. In some implementations, the extracted metadata is substituted into a selected signal from the clause library. This can simplify an artifact creation process as specific information for the artifact can be automatically substituted in rather than being manually entered by a user. The extracted metadata can be used, additionally or alternatively, for downstream processes, such as creating an account, establishing agreements with other financial institutions, communicating with an issuing institution, and so forth. While extracting metadata from draft artifacts is described herein, it will be appreciated that the platform can, additionally or alternatively, provide a user interface in which users can enter metadata. Said metadata can be used to fill in tokenized signals and/or for other purposes such as fulfilment. In some implementations, rather than or in addition to uploaded draft artifacts (e.g., draft signals for a draft artifact), a user can select signals from a signal library for generating an artifact, and the platform can substitute metadata into the selected signals to generate a final artifact.

In some implementations, the platform matches signals in the uploaded artifact to pre-approved language in the signal library. The signal library can be built from previously-approved SBLCs, guarantees, etc. In some implementations, the platform applies business logic rules, for example based on a match score determined by a model. For example, the platform can insert signals or other language that is appropriate for the particular artifact at issue. As an example, if an SBLC involves an entity in the European Union, the platform can determine that language regarding the GDPR should be included in the SBLC or guarantee and can automatically add the language to the artifact. Such language can be stored in the signal library or in another data store. Business logic can also be used to identify, for example, missing signal types in a signal library. For example, a signal type can be a type such as “assignment” or “choice of law.” The platform can analyze an artifact and determine if a signal having a particular signal type is missing. In some implementations, the platform is configured to classify certain signal types as required or optional, and the platform may not allow finalization of an artifact until there is at least one signal for all required signal types. In some implementations, the platform is configured to recommend one or more signals of a particular signal type when a signal with the particular signal type is missing from an artifact.

In some cases, a user may submit an artifact that contains signals that could benefit from revision or that require revision. In some implementations, the platform can recommend one or more fallback signals from a signal library that can be used to replace a signal in an uploaded artifact, for example as described herein. In some implementations, fallback signals can be ranked. For example, the platform can be configured to rank fallback signals as good, better, and best, in a numerical order, etc. In some implementations, the platform provides an explanation for the ranking. The explanations can be stored in the signal library. In some implementations, fallback signals can be more or less liberal than other fallback signals. A beneficiary may typically prefer more liberal signals so they can be more easily draw on the artifact, assign the artifact, etc., while an obligor may prefer less liberal signals to reduce the likelihood of paying out and/or to maintain control and input over assignments.

Signal rankings can be manually defined, determined based on past signal usage (e.g., based on signal usage of all users of the platform and/or based on signal usage of a party or entity with interest in an artifact (e.g., beneficiary, applicant)), etc. In some implementations, signals in the signal library can be labeled as being automatically approved or as requiring further review. For example, automatically approved signals can be signals that are commonly used and generally considered to have an acceptable risk by the obligor. Signals that require further review can be signals that the obligor may approve under some circumstances, but for which manual review is needed. In some implementations, the signal library includes rejected signals. Rejected signals can be signals that the obligor has determined should not be included in artifacts. This can be significant because it can enable the platform to automatically reject certain signals if they are the same as or close to a rejected signal and can reduce the likelihood that a signal that should be rejected is allowed in a final artifact.

In some implementations, the platform learns applicant behavior and uses this information to recommend fallback signals. For example, if a signal would ordinarily be ranked number five in a list of recommended signals, but the applicant frequently uses that signal, it can be raised to a higher ranking (e.g., ranked number one). This can help to improve consistency between artifacts as the signals that the applicant is most likely to want to use can be shown at the top of a list of recommended fallback signals. Such functionality can also improve the applicant experience, as the signals they commonly used are presented in a prominent position, rather than the applicant having to look through a potentially long list for their desired signal.

The platform can present the model's recommendations (fallback signals) to the client. The client can review the recommendations and can select recommendations to include in the artifact. In some cases, the client may enter custom text for a particular signal, rather than accepting a recommendation. In such cases, the custom text can be routed to the guarantor for review and approval and/or can be automatically reviewed by the platform to determine whether the custom text should be approved, rejected, or routed for manual review. Once all the signals are in an approved state (e.g., approved by both the client and the guarantor), the platform can share the artifact with the beneficiary.

The recommended fallback signals can be selected from a signal library based on similarity between a signal in the proposed text and signals (e.g., approved signals) in the signal library. The similarity can be determined using various techniques, such as Levenshtein distance, Jaro-Winkler distance, cosine similarity, L1 distance, L2 distance, etc. For example, in vector-based approaches, such as L1 distance, L2 distance, or cosine similarity, the platform can compute a vector representation of the signal and the fallback signals in the signal library, and can perform one or more pairwise comparisons between the vector representation of the signal and the vector representations of the fallback signals in the signal library.

In some implementations, determining recommended fallback signals involves finding a correspondence between a signal in the proposed text and one or more approved signals in the signal library. The platform can determine a correspondence score, for example based at least in part on Levenshtein distance, Jaro-Winkler distance, cosine similarity, L1 distance, L2 distance, etc. In some implementations, the correspondence score is not necessarily a strict comparison of how closely the text of a signal matches with that of a fallback signal but can, additionally or alternatively, be based on a similarity of the meaning between a signal and a fallback signal or other criteria.

In some implementations, fallback signals are not client-specific. That is, any approved signal in the signal library may be suggested as a fallback signal. In other implementations, fallback signals are client-specific. For example, suggested fallback signals can be identified from signals that the client has previously used or submitted. This can be significant for maintaining consistency among artifacts for the same client, and can also be important for maintaining confidentiality so that signals used by one client are not shared with another client.

In some implementations, a platform can provide an interface (e.g., a web-based portal) for applicants to upload proposed SBLC text, manage edits, review feedback, and so forth. In some implementations, the portal includes a tracker that shows a color-coded representation of the identified signals. The color coding can indicate if particular signals are acceptable to the guarantor (e.g., are approved), need to be revised, an alternative fallback signal needs to be selected, or further review by the guarantor is needed. For example, some signals can be automatically approved if their similarity to approved signals in a signal library is greater than a threshold value, while others may need to be manually approved by the financial institution. In some implementations, the platform identifies words within signals that can significantly change the meaning of a signal. For example, “This agreement can be assigned with the written consent of the obligor” can be similar to the phrase, “This agreement can be assigned without the written consent of the obligor,” even though these phrases have opposite meanings. In some implementations, such issues can be mitigated by generating vector representations of signals, wherein the vector space is configured such that negations cause vectors to have relatively low similarity.

An applicant can use the user interface to approve signals, select fallback signals, propose different text for a signal, and so forth. In some implementations, the platform can act as an all-in-one platform for use by the applicant and the guarantor. In some implementations, the platform can offer functionality for beneficiaries as well. For example, in a first portion of an SBLC process, the applicant and guarantor can utilize the platform to reach an agreed-upon text for the SBLC. In a second portion, the beneficiary can utilize the platform to review the agreed-upon text and, in some cases, can suggest further changes, sign the SBLC, etc.

One advantage of the platform described herein is that applicants can receive at least some feedback immediately or very soon after submitting proposed text. For example, the platform can provide feedback regarding clauses that are approved, provide recommendation fallback provisions, and so forth, even if other clauses in the SBLC are outstanding and still need to be reviewed (e.g., escalated for manual review). This can significantly reduce the total time needed to prepare an SBLC or guarantee, as the applicant can take actions rather than waiting idly while the guarantor reviews the proposed text.

### Example Implementations

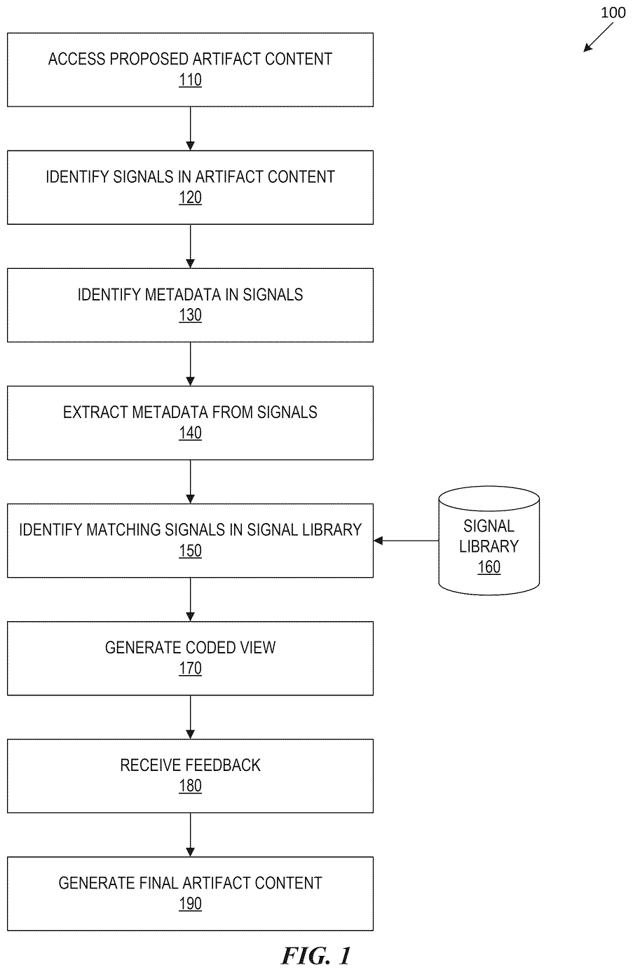

FIG. 1 is a flowchart that illustrates an example process 100 for generating an artifact according to some implementations. At operation 110, a system can receive proposed artifact content. For example, the proposed artifact content can be uploaded by a user to the system via a web interface. At operation 120, the system can identify signals in the artifact content. For example, the system can provide the artifact contents in whole or in chunks to a machine learning model (e.g., a large language model), which can identify signals within the artifact content. At operation 130, the system can identify metadata in the signals. For example, a signal can contain generic data and specific data. The specific data can be considered metadata. At operation 140, the system can remove the metadata from the signals. In some implementations, the system tokenizes the metadata. The tokens can indicate a type of content or can be generic tokens that indicate where metadata can be placed within a signal. For example, a specific token can be {businessName} or {guarantorName} while a generic token can be {token 1} or {token2}.

At operation 150, the system can match the signals to signals in a signal library 160. For example, the system can match tokenized signals extracted from the artifact content to tokenized signals in the signal library 160. In some implementations, the signals are not tokenized and matching can be carried out on non-tokenized signals. As described herein, matching can be based on similarity and can use various similarity measures, such as Levenshtein distance, Jaro-Winkler similarity, cosine similarity, L1 distance, L2 distance, and so forth. In some implementations, matching signals can include determining a match score, automatically approving signals, determining fallback (alternative) signals, etc. At operation 170, the system can generate a coded view of the signals. The coded view can be a view that shows signals and their status. For example, a status can be indicated using colors, icons, and so forth. The status can indicate if a signal is approved, waiting review, needs revision (e.g., to select a fallback signal), etc.

At operation 180, the system can receive feedback from the user. The feedback can be, for example, a selection of a fallback signal, confirmation of signals, etc. At operation 190, once all the signals have been approved, the system can generate final artifact content. In some implementations, the system can be configured to provide the final artifact content to a beneficiary or other parties, or to other groups or functions of the guarantor, which may typically be a financial institution.

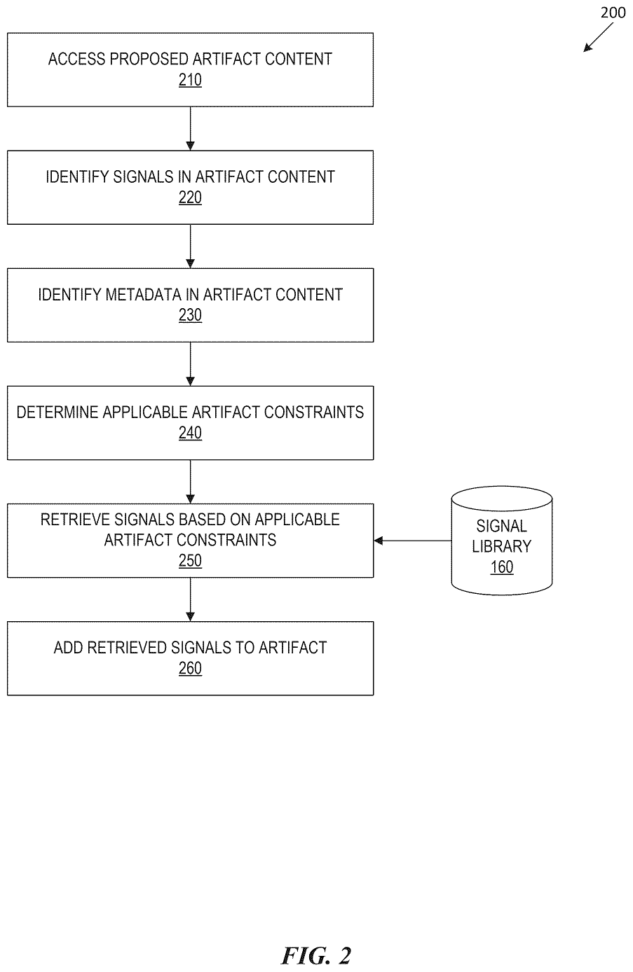

FIG. 2 is a flowchart that illustrates an example process for determining and applying artifact constraints according to some implementations. The process 200 can be performed on a computer system. At operation 210, the system can access proposed artifact content, for example proposed artifact content uploaded by a user. At operation 220, the system can identify signals artifact content, for example using a machine learning model such as a large language model. At operation 230, the system can identify metadata in the artifact content (e.g., metadata in the identified signals). At operation 240, the system can determine applicable artifact constraints based on the artifact content, the metadata, or both. For example, the system can determine applicable artifact constraints based on entity type, location of a party listed in the artifact content, and so forth. For example, if a party is located in the EU, an artifact constraint may indicate that GDPR provisions should be included. At operation 250, the system can retrieve signals based on the determine applicable artifact constraints. The signals can be retrieved from the signal library 160, although in some implementations artifact constraint signals are stored in a different library. At operation 260, the system can add the retrieved signals to the artifact.

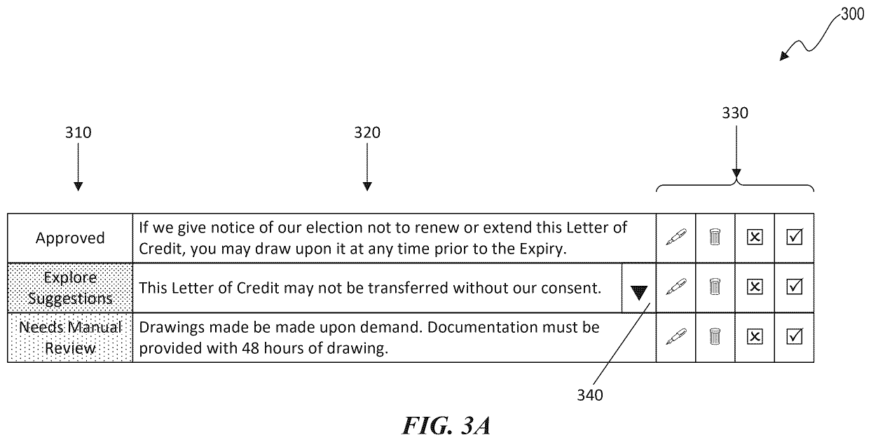

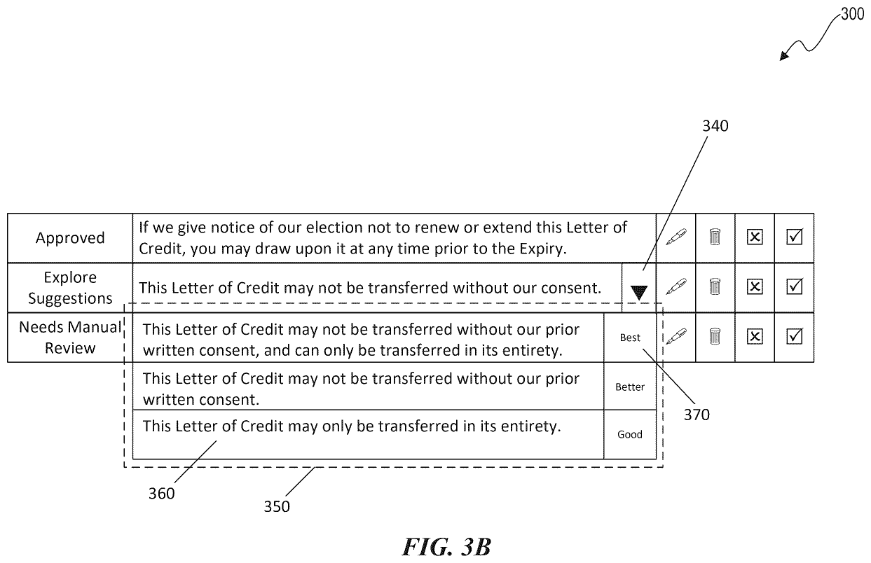

FIG. 3A is a drawing that illustrates an example user interface according to some implementations. The user interface 300 a number of rows, with each row corresponding to a signal. Within each row, the user interface can include a status indicator 310, content 320 of the corresponding signal. and/or controls 330. In some implementations, a row can include a dropdown 340 or other input that enables a user to make a selection of a fallback signal.

As shown in FIG. 3A, the status indicator 310 can take various values that indicate if a signal is approved, has suggested fallback signals for a user to review and select from, needs manual review. Other statuses are possible, such as rejected, needs counterparty approval, and so forth. In some implementation, the status indicator 310 includes text. In some implementation, the status indicator 310 includes color. Other indications are possible additionally or alternatively for key-coding status, such as icons, borders (e.g., colored borders), shapes, etc. In some implementations, the controls 330 includes one or more controls such as controls to edit, delete, reject, or approve a signal. For example, in some implementations, users can manually edit signal text within the platform. In some implementations, when a user manually edits text, the platform can analyze the edited signal to determine if it is approved or to otherwise assign a status to the edited signal.

FIG. 3B is a drawing that illustrates another view of the user interface 300 according to some implementations. FIG. 3B shows a dropdown panel 350 that can be displayed when a user selects (e.g., clicks or touches) the dropdown 340. In some implementations, there may not be a dropdown 340, and the dropdown panel 350 can be displayed whenever a user touches a row in the user interface 300 or a part of a row, such as content 320. The dropdown panel 350 can include one or more signals 360. In some implementations, the signals 360 are ranked, for example as “Best,” “Better,” and “Good.” In some implementations, the rankings 370 can be color-coded, numbered, or otherwise key-coded. In some implementations, the one or more signals 360 can be sorted, but an explicit ranking may not be shown. As described herein, the sorting/ranking can be based on usage, the contents of signals (e.g., more restrictive signals may generally be preferred over less restrictive signals), etc.

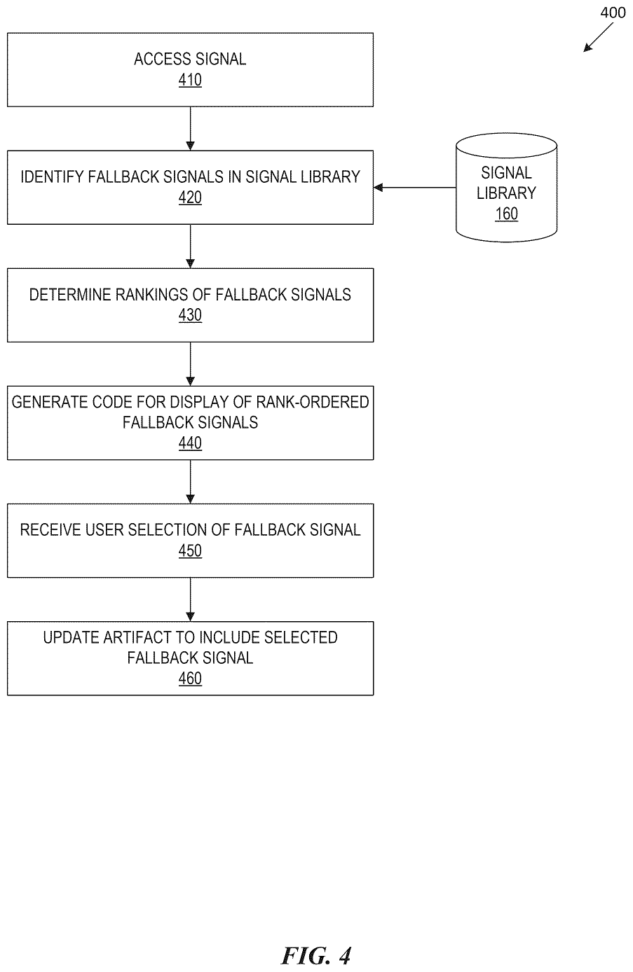

FIG. 4 is a flowchart that illustrates an example process for determining a fallback signal and updating an artifact according to some implementations. At operation 410, the platform can access a signal that is part of an artifact. At operation 420, the platform can analyze the signal to identify one or more fallback signals in a signal library 160, for example using a machine learning model such as a large language model. The analysis can include, for example, determining a type of the signal (e.g., assignment signal, choice of law signal, forum selection signal etc.) and/or determining similarity between the signal and fallback signals in the signal library 160. At operation 430, the platform can determine rankings of the one or more fallback signals. The rankings can be determined based on, for example, one or more of: similarity to the accessed signal, specified preferences (e.g., preferences specified in the signal library 160) of the obligor, applicant, and/or beneficiary, or usage frequency (e.g., signals that are frequently used by the applicant can be assigned a higher rank than signals that are less frequently used). Other information can be used additionally or alternatively to rank the fallback signals. At operation 440, the platform can generate code for displaying the rank-ordered fallback signals to a user (e.g., HTML code, JavaScript code, etc.). At operation 450, the platform can receive a user selection of a fallback signal. At operation 460, the platform can update the artifact to include the selected fallback signal (e.g., to replace the accessed signal with the selected fallback signal).

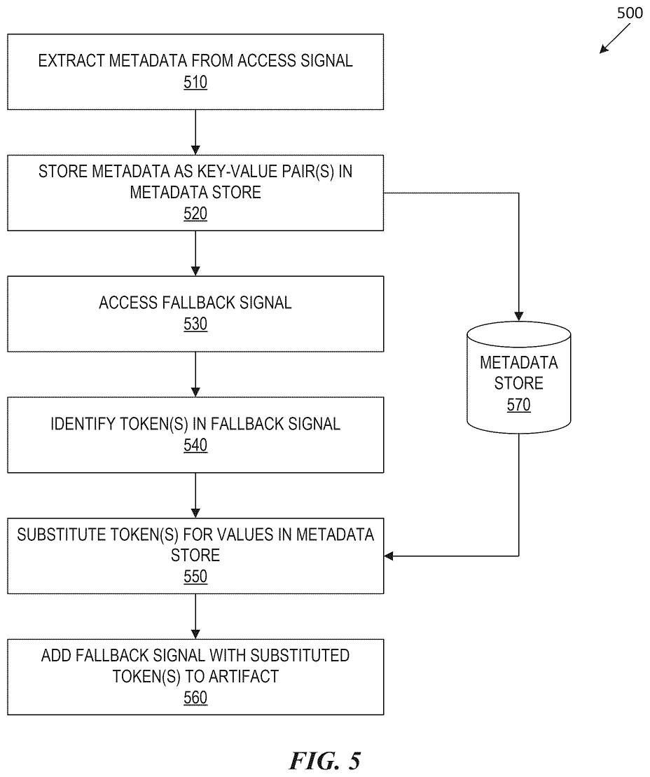

FIG. 5 is a flowchart that illustrates an example process for updating an artifact with a fallback signal according to some implementations. The process 500 can be performed by the platform on one or more computer systems. At operation 510, the platform can extract metadata from an accessed signal in an artifact (e.g., a signal in a draft artifact submitted by a user via a user interface). The platform can extract the metadata using a machine learning model, such as a large language model. At operation 520, the platform can store the metadata in a metadata store 570. In some implementations, the metadata is stored as key-value pairs, for example as JSON, YAML, or in another markup language. In some implementations, the metadata is stored in a database, such as an SQL database. At operation 530, the platform can access a fallback signal, for example a fallback signal selected by a user via a user interface. The fallback signal can be a tokenized fallback signal, such as “{obligor} enters into this agreement with {beneficiary}” where {obligor} and {beneficiary} represent tokens. The tokens can identify an expected type of value to be inserted into the fallback signal at the token location. At operation 550, the system can substitute tokens for values in the metadata store 570. For example, a key-value pair in the metadata store can be “beneficiary: ‘Smith's Exporting LLC’” where “beneficiary” is the key and “Smith's Exporting LLC” is the value. The substituted fallback signal can then be, for example, “{obligor} enters into this agreement with Smith's Exporting LLC.” At operation 560, the platform can add the fallback signal with substituted tokens into the artifact. For example, replacing a signal in the artifact with a selected fallback signal in which tokens have been substituted for values in the metadata store 570.

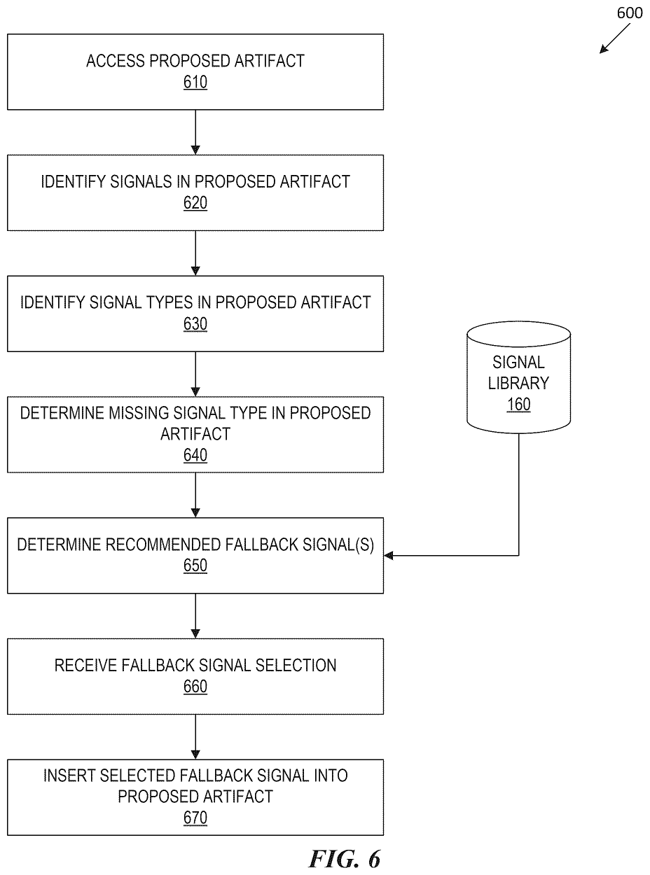

FIG. 6 is a flowchart that illustrates an example process 600 for identifying missing signals and inserting signals into an artifact according to some implementations. At operation 610, a platform can access a proposed artifact, for example a proposed artifact uploaded by a user via a user interface such as a web interface. At operation 620, the platform can identify one or more signals in the proposed artifact, for example using an artificial intelligence model such as LLM as described herein. At operation 630, the platform can, using the artificial intelligence model and/or another model, determine signal types of the signals in the proposed artifact. At operation 640, the platform can determine a missing signal type in the proposed artifact. For example, the platform can determine that certain signal types are required in the artifact (for example, based on artifact constraints, legal requirements, etc.) or can determine that a recommended signal type is missing. At operation 650, the platform can determine one or more recommended fallback signals from a signal library 160. For example, the platform can select recommended fallback signals based on signal type. As described herein, the signal library 160 can have rankings and/or other information, such as historical usage by users of the platform or by the user or the user's organization, can be used to determine the recommended fallback signals. At operation 660, the platform can receive a user selection of a fallback signal. At operation 670, the platform can insert the selected fallback signal into the proposed artifact. The process can continue until all required signal types are present in the proposed artifact.

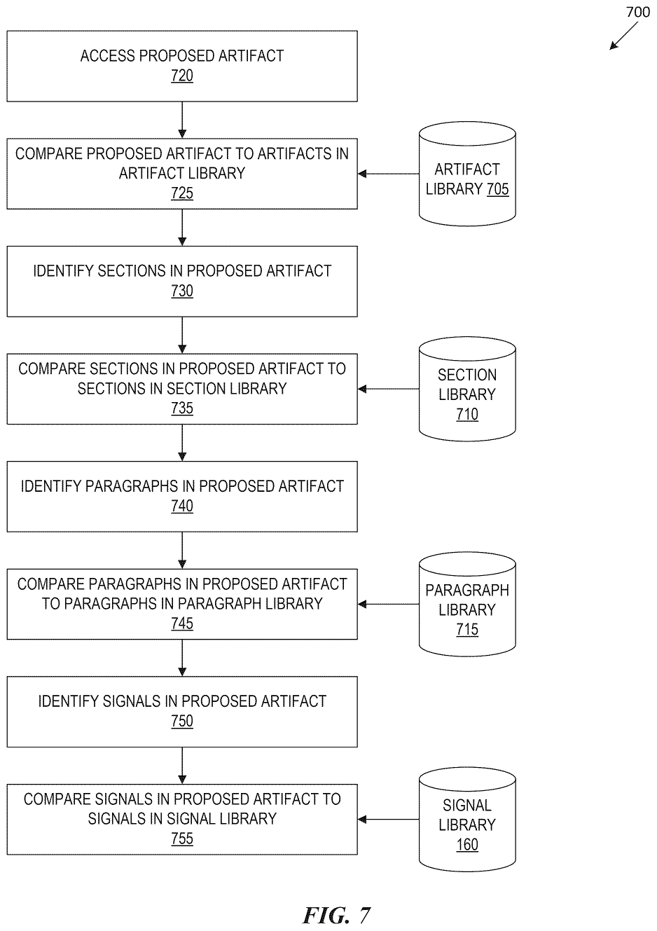

As described herein, often paragraphs, sections, or even entire artifacts are reused. In some implementations, analysis of a proposed artifact can proceed in a layered or cascaded manner, which can limit signal-level analysis to a subset of signals in an artifact. FIG. 7 is a flowchart that illustrates an example cascaded analysis 700 according to some implementations. At operation 720, a platform can access a proposed artifact, such as an artifact uploaded by a user. At operation 725, the platform can compare the proposed artifact to other artifacts in an artifact library 705. In some implementations, the comparison can be performed after removing metadata and/or tokenizing the proposed artifact. If there is a match (e.g., similarity above a threshold amount) in the artifact library 705 for the proposed artifact, the entire artifact can be approved and further analysis may not be performed. If not, at operation 730, the platform can identify sections in the proposed artifact, for example using an artificial intelligence model such as an LLM. At operation 735, the platform can compare sections in the proposed artifact to sections in a section library 710. If there is a match between an identified section and a section in the section library 710 (e.g., similarity above a threshold value), then further analysis of that section may not be performed (e.g., the entire section can be approved). For any remaining sections, the platform can, at operation 740, identify paragraphs in the proposed artifact and can compare them to paragraphs in a paragraph library 715 at operation 750. If there is a match between a paragraph in the proposed artifact and an artifact in the paragraph library 715, further analysis of the paragraph may not be performed. At operation 750, the platform can identify signals in any parts of the artifact that were not already matched at the artifact, section, or paragraph levels, and can compare those signals to signals in a signal library 160 at operation 755.

While illustrated as separate data stores in FIG. 7, it will be appreciated that the artifact library 705, section library 710, paragraph library 715, and signal library 160 are not necessarily different and can be the same data store in some implementations. Further, while FIG. 7 illustrates analysis at the artifact, section, paragraph, and signal levels, it will be appreciated that other levels can be used additionally or alternatively, such as page-level comparison, sentence-level comparisons, and so forth.

### Computing Environments

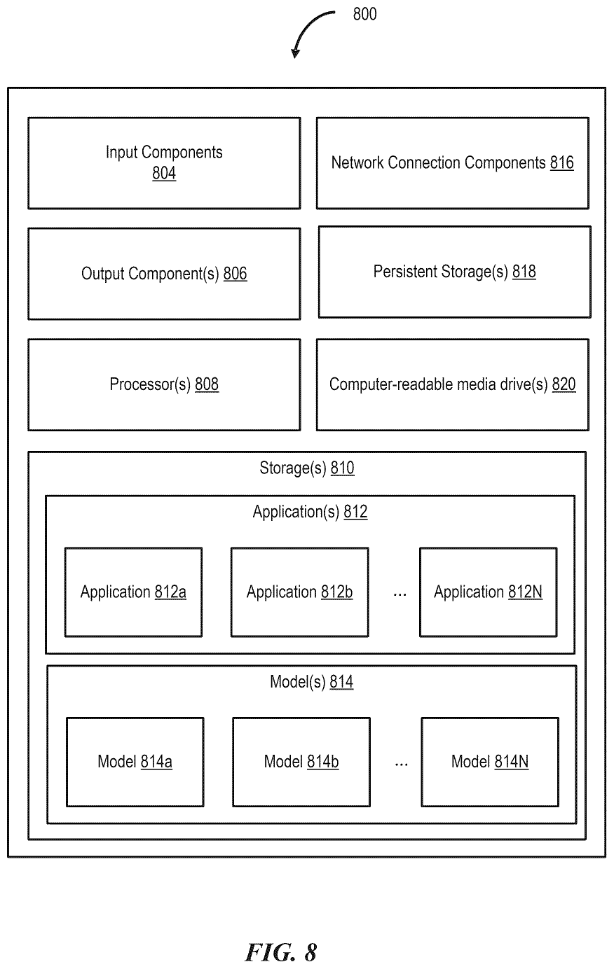

FIG. 8 is a block diagram showing some of the components typically incorporated in at least some of the computer systems and other devices on which the disclosed platform operates. In various implementations, these computer systems and other device(s) 800 can include server computer systems, desktop computer systems, laptop computer systems, netbooks, mobile phones, personal digital assistants, televisions, cameras, automobile computers, electronic media players, web services, mobile devices, watches, wearables, glasses, smartphones, tablets, smart displays, virtual reality devices, augmented reality devices, etc. In various implementations, the computer systems and devices include zero or more of each of the following: input components 804, including keyboards, microphones, image sensors, touch screens, buttons, touch screens, track pads, mice, CD drives, DVD drives, 3.5 mm input jack, HDMI input connections, VGA input connections, USB input connections, or other computing input components; output components 806, including display screens (e.g., LCD, OLED, CRT, etc.), speakers, 3.5 mm output jack, lights, LED's, haptic motors, HDMI output connections, VGA output connections, USB output connections, or other output-related components; processor(s) 808, including a central processing unit (CPU) for executing computer programs, a graphical processing unit (GPU) for executing computer graphic programs and handling computing graphical elements; storage(s) 810, including at least one computer memory for storing programs (e.g., application(s) 812, model(s) 814, and/or other programs) and data while they are being used, an operating system including a kernel, and device drivers; a network connection component(s) 816 for the computer system to communicate with other computer systems and to send and/or receive data, such as via the Internet or another network and its networking hardware, such as switches, routers, repeaters, electrical cables and optical fibers, light emitters and receivers, radio transmitters and receivers, and the like; a persistent storage(s) device 818, such as a hard drive or flash drive for persistently storing programs and data; and computer-readable media drives 820 (e.g., at least one non-transitory computer-readable medium) that are tangible storage means that do not include a transitory, propagating signal, such as a floppy, CD-ROM, or DVD drive, for reading programs and data stored on a computer-readable medium. While computer systems configured as described above are typically used to support the operation of the platform, those skilled in the art will appreciate that the platform may be implemented using devices of various types and configurations, and having various components.

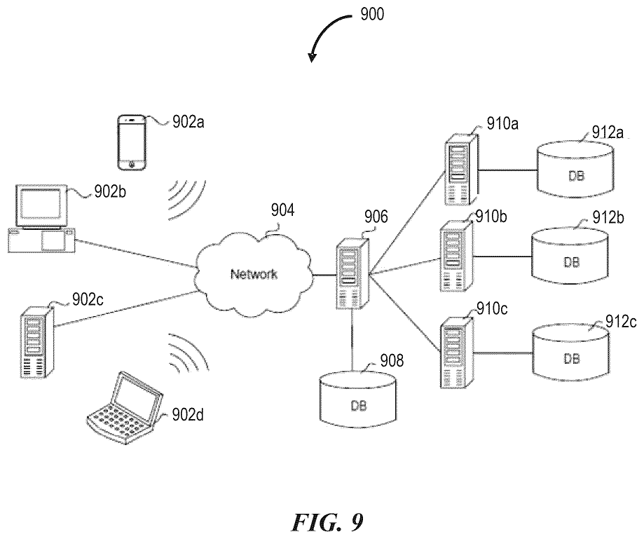

FIG. 9 is a system diagram illustrating an example of a computing environment in which the disclosed platform operates in some implementations. In some implementations, environment 900 includes one or more client computing devices 902a-d. For example, the computing devices 902a-d can comprise distributed entities a-d, respectively. Client computing devices 902 operate in a networked environment using logical connections through network 904 to one or more remote computers, such as a server computing device. In some implementations, client computing devices 902 may correspond to device 800 (FIG. 8).

In some implementations, server computing device 906 is an edge server which receives client requests and coordinates fulfillment of those requests through other servers, such as servers 910a-c. In some implementations, server computing devices 906 and 910 (e.g., 910a, 910b, 910c) comprise computing systems. Though each server computing device 906 and 910 is displayed logically as a single server, server computing devices can each be a distributed computing environment encompassing multiple computing devices located at the same or at geographically disparate physical locations. In some implementations, each server computing device 910 corresponds to a group of servers. In some implementations, one or more server computing device 910 is a virtualized server and can operate on physical hardware that runs multiple virtualized servers.

Client computing devices 902 and server computing devices 906 and 910 can each act as a server or client to other server or client devices. In some implementations, server computing devices (906, 910a-c) connect to a corresponding database (908, 912a-c). As discussed above, each server 910 can correspond to a group of servers, and each of these servers can share a database or can have its own database and/or other data storage capabilities.

The platform can utilize one or more machine learning models. The one or more machine learning models can include supervised learning models, unsupervised learning models, semi-supervised learning models, and/or reinforcement learning models. Examples of machine learning models suitable for use with the present technology include, but are not limited to: large language models, regression algorithms (e.g., ordinary least squares regression, linear regression, logistic regression, stepwise regression, multivariate adaptive regression splines, locally estimated scatterplot smoothing), instance-based algorithms (e.g., k-nearest neighbor, learning vector quantization, self-organizing map, locally weighted learning, support vector machines), regularization algorithms (e.g., ridge regression, least absolute shrinkage and selection operator, elastic net, least-angle regression), decision tree algorithms (e.g., classification and regression trees, Iterative Dichotomiser 3(ID 3 ), C4.5, C5.0, chi-squared automatic interaction detection, decision stump, M5, conditional decision trees), decision engines, rules engines, Bayesian algorithms (e.g., naïve Bayes, Gaussian naïve Bayes, multinomial naïve Bayes, averaged one-dependence estimators, Bayesian belief networks, Bayesian networks), clustering algorithms (e.g., k-means, k-medians, expectation maximization, hierarchical clustering), association rule learning algorithms (e.g., apriori algorithm, ECLAT algorithm), artificial neural networks (e.g., perceptron, multilayer perceptrons, back-propagation, stochastic gradient descent, Hopfield networks, radial basis function networks), deep learning algorithms (e.g., convolutional neural networks, recurrent neural networks, long short-term memory networks, stacked auto-encoders, deep Boltzmann machines, deep belief networks), dimensionality reduction algorithms (e.g., principle component analysis, principle component regression, partial least squares regression, Sammon mapping, multidimensional scaling, projection pursuit, discriminant analysis), time series forecasting algorithms (e.g., exponential smoothing, autoregressive models, autoregressive with exogenous input (ARX) models, autoregressive moving average (ARMA) models, autoregressive moving average with exogenous inputs (ARMAX) models, autoregressive integrated moving average (ARIMA) models, autoregressive conditional heteroskedasticity (ARCH) models), blackboard machine learning models, and ensemble algorithms (e.g., boosting, bootstrapped aggregation, AdaBoost, blending, stacking, gradient boosting machines, gradient boosted trees, random forest).

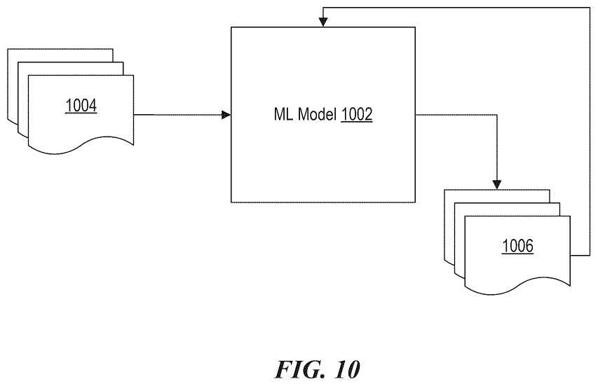

In various implementations, the one or more machine learning models can be trained on training data or a training set (discussed in more detail below in relation to FIG. 10). The training data or training set can be created by generating pairs of features (e.g., feature vectors) and/or ground-truth labels/values based on any of the data stored in databases 908 and 912. During training, the machine learning models can be adjusted or modified to fit the models to the training data by, for example, adjusting or modifying model parameters, such as weights and/or biases, so as to minimize some error measure (e.g., a difference between a predicted value and an actual/ground-truth value) over the training data. The error measure can be evaluated using one or more loss functions. Examples of loss functions that can be used include, but are not limited to, cross-entropy loss, log loss, hinge loss, mean square error, quadratic loss, L2 loss, mean absolute loss, L1 loss, Huber loss, smooth mean absolute error, log-cosh loss, or quantile loss. The trained machine learning models can then be applied to test data or validation data (e.g., holdout dataset) to generate predictions (e.g., predicted values or labels). The test data or validation data can also come from data that is stored in databases 908 and 912 (e.g., unlabeled data to generate predictions for). In some implementations, the machine learning models can be retrained to further modify/adjust model parameters and improve model performance. The machine learning models can be retrained on existing and/or new training data, training data, or validation data so as to fine-tune the model parameters to better fit the data and yield a different error measure over the data (e.g., further minimization of the error, or to increase the error to prevent overfitting). More specifically, the model can be further adjusted or modified (e.g., fine-tuned model parameters such as weights and/or biases) so as to alter the yielded error measure. Such retraining can be performed iteratively whenever it is determined that adjustments or modifications to the machine learning models are desirable.

Though databases 908 and 912 are displayed logically as single units, databases 908 and 912 can each be a distributed computing environment encompassing multiple computing devices, can be located within their corresponding server, or can be located at the same or at geographically disparate physical locations.

Network 904 can be a local area network (LAN) or a wide area network (WAN), but can also be other wired or wireless networks. In some implementations, network 904 is the Internet or some other public or private network. Client computing devices 902 are connected to network 904 through a network interface, such as by wired or wireless communication. While the connections between server computing device 906 and server computing device 910 are shown as separate connections, these connections can be any kind of local, wide area, wired, or wireless network, including network 904 or a separate public or private network.

### Machine Learning Model(s)

FIG. 10 is an illustrative diagram illustrating a machine learning model, in accordance with some implementations of the present technology.

In some implementations, the machine learning model 1002 can include one or more neural networks or other machine learning models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some implementations, each individual neural unit may have a summation function which combines the values of all its inputs together. In some implementations, each connection (or the neural unit itself) may have a threshold function such that the signal must surpass the threshold before it propagates to other neural units. These neural network systems may be self-learning and trained, rather than explicitly programmed, and can perform significantly better in certain areas of problem solving, as compared to traditional computer programs. In some implementations, neural networks may include multiple layers (e.g., where a signal path traverses from front layers to back layers). In some implementations, back propagation techniques may be utilized by the neural networks, where forward stimulation is used to reset weights on the “front” neural units. In some implementations, stimulation and inhibition for neural networks may be more free flowing, with connections interacting in a more chaotic and complex fashion.

As an example, with respect to FIG. 10, machine learning model 1002 can take inputs 1004 and provide outputs 1006. In one use case, outputs 1006 may be fed back to machine learning model 1002 as input to train machine learning model 1002 (e.g., alone or in conjunction with user indications of the accuracy of outputs 1006, labels associated with the inputs, or with other reference feedback information). In another use case, machine learning model 1002 may update its configurations (e.g., weights, biases, or other parameters) based on its assessment of its prediction (e.g., outputs 1006) and reference feedback information (e.g., user indication of accuracy, reference labels, or other information). In another use case, where machine learning model 1002 is a neural network, connection weights may be adjusted to reconcile differences between the neural network's prediction and the reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the machine learning model 1002 may be trained to generate better predictions.

As an example, where the prediction models include a neural network, the neural network may include one or more input layers, hidden layers, and output layers. The input and output layers may respectively include one or more nodes, and the hidden layers may each include a plurality of nodes. When an overall neural network includes multiple portions trained for different objectives, there may or may not be input layers or output layers between the different portions. The neural network may also include different input layers to receive various input data. Also, in differing examples, data may input to the input layer in various forms, and in various dimensional forms, input to respective nodes of the input layer of the neural network. In the neural network, nodes of layers other than the output layer are connected to nodes of a subsequent layer through links for transmitting output signals or information from the current layer to the subsequent layer, for example. The number of the links may correspond to the number of the nodes included in the subsequent layer. For example, in adjacent fully connected layers, each node of a current layer may have a respective link to each node of the subsequent layer, noting that in some examples such full connections may later be pruned or minimized during training or optimization. In a recurrent structure, a node of a layer may be again input to the same node or layer at a subsequent time, while in a bi-directional structure, forward and backward connections may be provided. The links are also referred to as connections or connection weights, referring to the hardware implemented connections or the corresponding “connection weights” provided by those connections of the neural network. During training and implementation, such connections and connection weights may be selectively implemented, removed, and varied to generate or obtain a resultant neural network that is thereby trained and that may be correspondingly implemented for the trained objective, such as for any of the above example recognition objectives.

In some implementations, machine learning model 1002 can be a blackboard machine learning model. A blackboard machine learning model can represent a blackboard architectural model where a common knowledge base (e.g., the “blackboard”) is updated by differing data sources. For instance, the blackboard machine learning model may be configured with a first problem (e.g., generate computing aspect impact levels for a set of computing aspects associated with a platform for a software application). The blackboard machine learning model may use information supplied by the data sources (e.g., one or more agents, interactive agents, interactive models, artificial intelligence models, machine learning models, etc.) to update the blackboard machine learning model with one or more partial solutions. In some implementations, the data sources may “publish” information to the blackboard machine learning model. When publishing information to the blackboard machine learning model, an agent or other data source may obtain information associated with the blackboard machine learning model (e.g., historical information uploaded to the blackboard machine learning model, relevant information associated with the agent, prior partial solutions, etc.) and may update the blackboard machine learning model with new information. As such, the data sources and the blackboard machine learning model work together to solve the first problem.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1. A method for generating an artifact, the method comprising:
receiving proposed artifact content from a user via a graphical interface;
identifying, using an artificial intelligence model, metadata in the proposed artifact content;
storing, in a first data storage element, the metadata,
wherein each metadata item of the metadata is stored as a key-value pair comprising a key and a value,
wherein the key of the key-value pair indicates a type of the metadata item, and
wherein the value of the key-value pair indicates a value of the metadata item;
analyzing, at a first level, the proposed artifact content, wherein the first level is one of a section level or a paragraph level;
determining, based on analyzing at the first level, that one or more components of the proposed artifact content are included in a set of components used in a plurality of other artifacts;
analyzing, using the artificial intelligence model, a portion of the proposed artifact content to identify a plurality of signals in the proposed artifact content, wherein the portion of the proposed artifact content does not include the one or more components of the proposed artifact content that are included in the set of components used in the plurality of other artifacts;
matching each signal of the plurality of signals to one or more approved signals in a signal library,
wherein matching comprises:
generating, using the artificial intelligence model, a vector representation of each signal of the plurality of signals, wherein the vector representation is configured such that negations cause vectors to have relatively low similarity;
accessing vector representations of the approved signals in the signal library:
performing pairwise comparisons between the vector representation of each signal and the vector representations of the approved signals using at least one of L1 distance, L2 distance, or cosine similarity; and
determining a match score based on the pairwise comparisons;
identifying, for a signal of the plurality of signals in the proposed artifact content, a first fallback signal and a second fallback signal,
wherein the first fallback signal is different from the second fallback signal,
wherein the first fallback signal is less liberal than the second fallback signal,
wherein a less liberal fallback signal comprises a fallback signal that, compared with a more liberal fallback signal, makes the artifact at least one of: more difficult to draw on or more difficult to assign to another entity, and
wherein the first fallback signal and the second fallback signal are determined based at least in part on the match score;
providing a key-coded representation of the identified signals to the user via the graphical interface,
wherein the key-coding identifies a status of each signal of the plurality of signals, and
wherein the status is at least one of: approved, needs applicant review, needs guarantor review, needs beneficiary review, or rejected;
receiving, from the user via the graphical interface, a selection of a fallback signal;
determining that all signals are in an approved status; and
generating a final artifact content,
wherein the final artifact content comprises the signals, and
wherein generating the final artifact content comprises inserting one or more metadata items into one or more fields of the signals.

2. The method of claim 1, wherein the metadata comprises at least one of: an applicant, a guarantor, a beneficiary, an expiry, an amount, an issuance date, or a reference number.

3. The method of claim 1, further comprising identifying a third fallback signal.

4. A method for generating a digital artifact, the method comprising:
accessing proposed digital artifact content for a digital artifact that is transmitted by a user via a user interface;
analyzing, at a first level, the proposed artifact content, wherein the first level is one of a section level or paragraph level;
determining, based on analyzing at the first level, that one or more components of the proposed artifact content are included in a set of components used in a plurality of other artifacts;
identifying, using an artificial intelligence model, a plurality of signals in a portion of the proposed digital artifact content, wherein the portion of the proposed artifact content does not include the one or more components of the proposed artifact content that are included in the set of components used in the plurality of other artifacts;
identifying, for a signal of the plurality of signals in the proposed digital artifact content, a first fallback signal and a second fallback signal in a signal library,
wherein identifying the first fallback signal and the second fallback signal comprises:
generating a vector representation of the signal, wherein the vector representation is configured such that negations cause vectors to have relatively low similarity;
accessing vector representations of fallback signals in the signal library; and
performing pairwise comparisons between the vector representation of the signal and the vector representations of the fallback signals in the signal library,
wherein the first fallback signal is different from the second fallback signal;
providing a key-coded representation of the identified signals,
wherein the key-coding indicates a status of each signal of the plurality of signals;
generating instructions to cause display of the first fallback signal and the second fallback signal to the user via the user interface;
receiving, from the user via the user interface, a selection of a fallback signal comprising the first fallback signal or the second fallback signal; and
updating the digital artifact to replace the identified signal with the fallback signal.

5. The method of claim 4, further comprising:
identifying, using the artificial intelligence model, metadata in the proposed digital artifact content,
wherein the identifying comprises identifying a type of each metadata item of the metadata and a value of each metadata item of the metadata;
storing the metadata; and
inserting into the fallback signal one or more values or one or more metadata items,
wherein the one or more values are inserted at token locations within the fallback signal based on one or more keys associated with the one or more metadata items.

6. The method of claim 4, wherein the first fallback signal and the second fallback signal are determined at least in part by:
finding a correspondence between the signal and approved signals in the signal library; and
determining, for each correspondence, a correspondence score.

7. The method of claim 6, wherein the correspondence score is determined using one or more of: L1 distance, L2 distance, Jaro-Winkler similarity, Levenshtein distance, or cosine similarity.

8. The method of claim 4, wherein the first fallback signal and the second fallback signal are determined at least in part by:
identifying a signal type of the signal; and
determining the first fallback signal and the second fallback signal based on the signal type, wherein the first fallback signal and the second fallback signal have a same signal type as the signal type of the signal.

9. The method of claim 4, further comprising:
determining a rank ordering of the first fallback signal and the second fallback signal,
wherein the generated instructions cause the first fallback signal and the second fallback signal to be displayed in the determined rank ordering.

10. The method of claim 9, wherein the rank ordering is based on one or more preference values stored in the signal library.

11. The method of claim 9, wherein the user is associated with an entity, wherein the rank ordering is based on past signal usage behavior of the entity.

12. The method of claim 5, wherein the metadata comprises at least one of:
an applicant, a guarantor, a beneficiary, an expiry, an amount, an issuance date, or a reference number.

13. The method of claim 4, further comprising identifying a third fallback signal.

14. The method of claim 4, further comprising:
identifying a missing signal type in the digital artifact;
determining one or more fallback signals having the missing signal type; and
presenting the one or more fallback signals having the missing signal type to the user via the user interface;
receiving a selection of a fallback signal of the one or more fallback signals having the missing signal type; and
inserting the selected fallback signal into the digital artifact.

15. A system comprising:
at least one hardware processor; and
a computer-readable non-transitory storage medium having instructions stored thereon which, when executed by the at least one hardware processor, cause the system to:
access proposed digital artifact content for a digital artifact from a user, wherein the proposed digital artifact content is transmitted by a user via a user interface;
analyze, at a first level, the proposed artifact content, wherein the first level is one of a section level or paragraph level;
determine, based on analyzing at the first level, that one or more components of the proposed artifact content are included in a set of components used in a plurality of other artifacts;
identify, using an artificial intelligence model, a plurality of signals in a portion of the proposed digital artifact content, wherein the portion of the proposed artifact content does not include the one or more components of the proposed artifact content that are included in the set of components used in the plurality of other artifacts;
identify, for a signal of the plurality of signals in the proposed digital artifact content, a first fallback signal and a second fallback signal in a signal library,
wherein identifying the first fallback signal and the second fallback signal comprises:
generating a vector representation of the signal, wherein the vector representation is configured such that negations cause vectors to have relatively low similarity;
accessing vector representations of fallback signals in the signal library; and
performing pairwise comparisons between the vector representation of the signal and the vector representations of the fallback signals in the signal library,
wherein the first fallback signal is different from the second fallback signal;
provide a key-coded representation of the identified signals,
wherein the key-coding indicates a status of each signal of the plurality of signals;
generate instructions to cause display of the first fallback signal and the second fallback signal to the user via the user interface;
receive, from the user via the user interface, a selection of a fallback signal comprising the first fallback signal or the second fallback signal; and
update the digital artifact to replace the identified signal with the fallback signal.

16. The system of claim 15, wherein the instructions are further configured to cause the system to:
identify, using the artificial intelligence model, metadata in the proposed digital artifact content,
wherein the identifying comprises identifying a type of each metadata item of the metadata and a value of each metadata item of the metadata;
store the metadata; and
insert into the fallback signal one or more values or one or more metadata items,
wherein the one or more values are inserted at token locations within the fallback signal based on one or more keys associated with the one or more metadata items.

17. The system of claim 15, wherein the first fallback signal and the second fallback signal are determined at least in part by:
matching the signal to approved signals in the signal library, wherein matching comprises determining a match score.

18. The system of claim 15, wherein the first fallback signal and the second fallback signal are determined at least in part by:
identifying a signal type of the signal; and
determining the first fallback signal and the second fallback signal based on the signal type, wherein the first fallback signal and the second fallback signal have a same signal type as the signal type of the signal.

19. The system of claim 16, wherein the metadata comprises at least one of:
an applicant, a guarantor, a beneficiary, an expiry, an amount, an issuance date, or a reference number.

20. The system of claim 15, wherein the instructions are further configured to cause the system to:
identify a missing signal type in the digital artifact;
determine one or more fallback signals having the missing signal type; and
present the one or more fallback signals having the missing signal type to the user via the user interface;
receive a selection of a fallback signal of the one or more fallback signals having the missing signal type; and
insert the selected fallback signal into the digital artifact.
